(19) United States
(12) Patent Application Publication
(10) Pub. No.: US 2009/0327853 A1
(43) Pub. Date: Dec. 31, 2009

(54) Comparing And Selecting Form-Based Functionality

(75) Inventors: Erin Elizabeth Dean, Bellevue, WA (US); Paula Guntaur, Seattle, WA (US); George Elias Hatoun, Bellevue, WA (US); Jeffrey Lawrence Schoner, Seattle, WA (US); Jesse Clay Satterfield, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/163,391

(22) Filed: Jun. 27, 2008

(51) Int. Cl. G06F 3/048; G06F 17/00

(52) U.S. Cl. 715/221; 715/810

(57) ABSTRACT

Methods, systems, and apparatuses for comparing and selecting form-based functionality may be provided. A user may select a particular functionality of an application. Various options for providing the functionality, which may be sorted by category, may be presented to a user in a single interface. The user may select each option to see more information about how the option would accomplish the desired functionality. The additional information may also preview the effect of choosing each option. If all of the options do not fit on the user's display, the options may be scaled to allow the display of more options.

### BACKGROUND

An interface for comparing and selecting form-based functionality is a process for presenting various options for implementing a function and enabling a user to compare and choose the right feature to complete their goal. In some situations, users may be unfamiliar with various options available to accomplish a particular task. For example, there are many ways to share a document, but users may not know which method best suits their needs. The conventional strategy is to present a menu of options, but this often causes problems because the conventional strategy does not convey the end user value, technical requirements, or setup investment time that will be needed. For example, opening up multiple dialog boxes, if the user is even aware of their existence, and trying to compare the features offered by each is a daunting and time consuming task.

### SUMMARY

Methods, systems, and apparatuses for comparing and selecting form-based functionality may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Methods, systems, and apparatuses for comparing and selecting form-based functionality may be provided. A user may select a particular functionality of an application. Various options for providing the functionality, which may be sorted by category, may be presented to a user in a single interface. The user may select each option to see more information about how the option would accomplish the desired functionality. The additional information may also preview the effect of choosing each option. If all of the options do not fit on the user's display, the options may be scaled to allow the display of more options.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an interface for comparing and selecting form-based functionality;

FIG. 2 is a flow chart of a method for comparing and selecting form-based functionality;

FIG. 3 is a flow chart of a subroutine used in the method of FIG. 2 for adjusting the size of elements in the display;

FIGS. 4A through 4C are screenshots illustrating different option sizes;

FIGS. 5A through 5D are block diagrams illustrating different layouts; and

FIG. 6 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

An interface for comparing and selecting form-based functionality may be provided. Consistent with embodiments of the present invention, a user may select a particular functionality of an application. Options for providing the functionality, which may be sorted by category, may be presented to a user in the interface. The user may select each option to see more information about how the option would accomplish the desired functionality. The additional information may also preview the effect of choosing each option. If all of the options do not fit on the user's display, the options may be scaled to allow the display of more options.

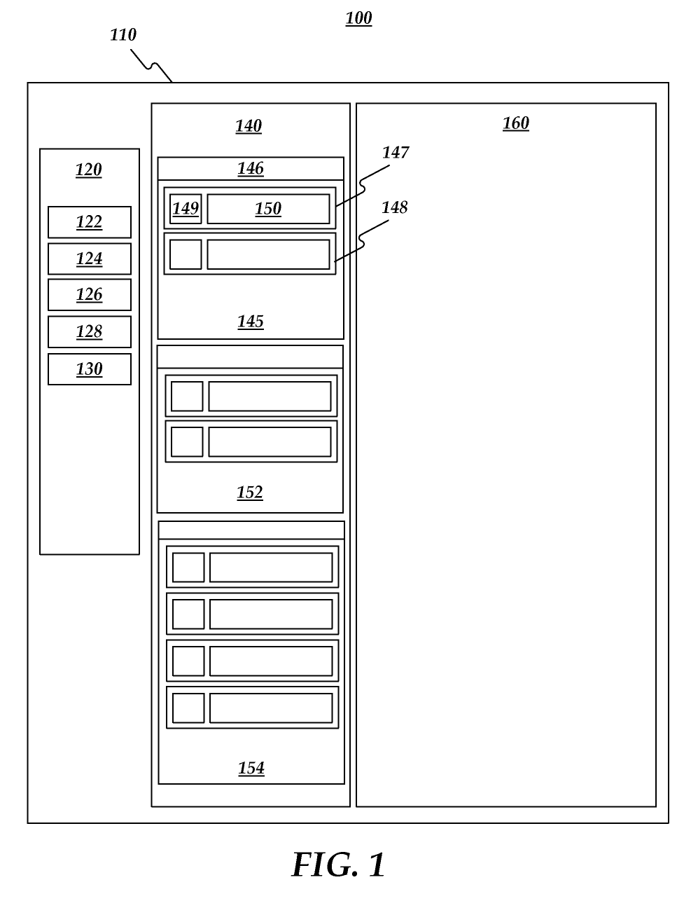

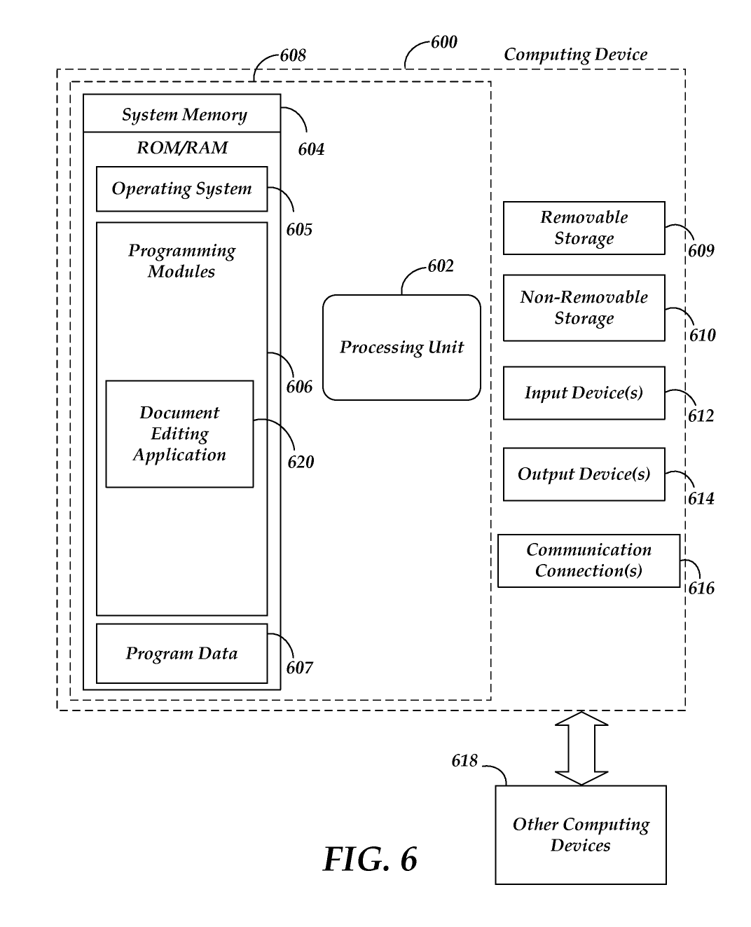

FIG. 1 is a block diagram of an interface 100 for comparing and selecting form-based functionality. Interface 100 may include a display area 110 that may provide a function menu 120, a button slab 140, and a button form slab 160. Function menu 120 may include a plurality of menu items 122, 124, 126, 128, 130. Button slab 140 may include a plurality of category displays 145, 152, 154. Category display 145 may include a category header 146 and a plurality of option buttons 147, 148. Option button 147 may include an icon 149 and a description 150. Interface 100 may be embodied in a computing device 600 that may be described in more detail by FIG. 6.

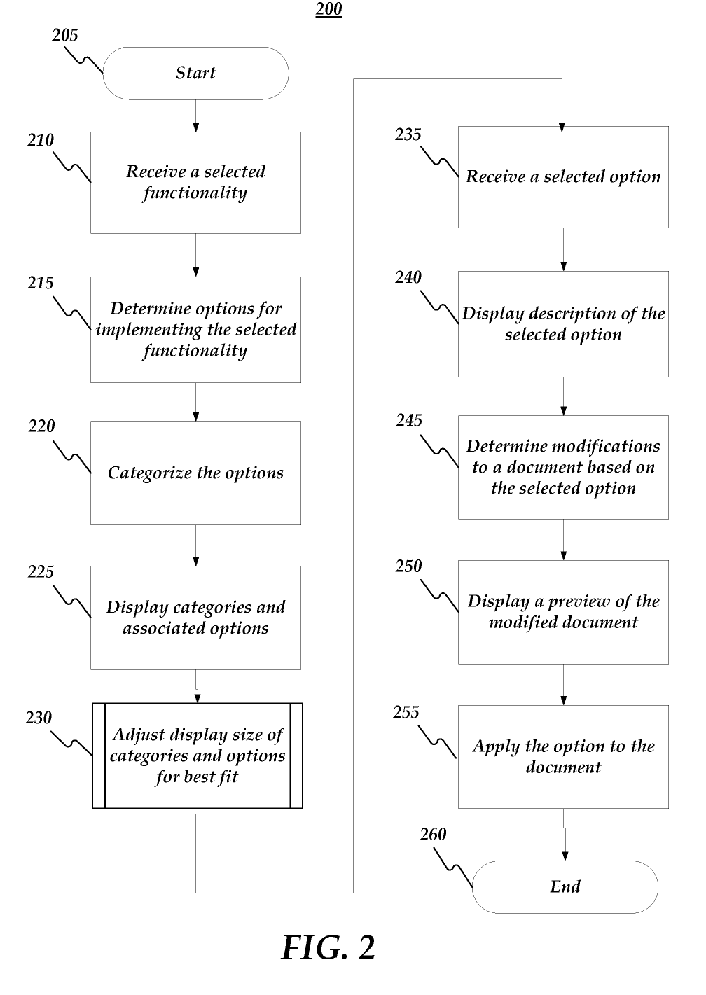

FIG. 2 is a flow chart of a method 200 consistent with an embodiment of the invention for comparing and selecting form-based functionality. Method 200 may be implemented using computing device 600 as described in more detail below with respect to FIG. 6. Ways to implement the stages of method 200 will be described in greater detail below. Method 200 may begin at starting block 205 and proceed to stage 210 where computing device 600 may receive a selected functionality. For example, a user may select a function from function menu 120 to save, share, inspect, protect, or publish an electronic document in a document editing application 620.

From stage 210, method 200 may advance to stage 215 where computing device 600 may determine at least one option for implementing the selected functionality. The at least one option may comprise a title, a label, an icon, an operation, and a description. The label and description of the at least one option may each provide different level of detail with respect to the at least one option. Consistent with embodiments of the invention, application 620 may use a statically defined option list associated with the selected functionality. Application 620 may also determine the at least one option dynamically, based on the document's properties. For example, a user may select a share function from function menu 120. Application 620 may determine options comprising sending the document via e-mail, sending the document as a PDF attachment, send a meeting request to discuss the document, publishing the document to a group workspace, send the document to another application, and printing the document from the statically defined list associated with the share function.

Application 620 may dynamically determine work flow options to publish the document when the document is seen on a collaborative server, depending on the work flows installed on the collaborative server. Application 620 may also dynamically determine options associated with other applications. For example, application 620 may determine an option to send the document to a presentation application to convert the document into a slide presentation. Application 620 may also restrict displayed options based on a policy defined for a plurality of users of application 620. For example, a network administrator may define a policy that restricts at least one option and/or at least one category from being displayed.

Method 200 may then advance to stage 220, where computing device 600 may categorize the option. For example, the options to send the document via e-mail and send the document as a PDF attachment may be associated with a send document category while the determined work flow options may be associated with a share point category. As a further example, an upload to web page option and a publish to blog option may be associated with a publish document category. Consistent with embodiments of the invention, application 620 may display all possible options for the application to accomplish the selected functionality. An aim consistent with embodiments of the invention is to create the impression with the user that button slab 140 displays an exhaustive list of all the ways for application 620 to accomplish the selected functionality.

From stage 220, method 200 may advance to stage 225 where computing device 600 may display the categories and associated options. Consistent with embodiments of the invention, the at least one category may be displayed as category display 145 in button slab 140. For example, application 620 may display a category name, such as send document, as category header 146. The at least one option associated with category header 146, e.g., send the document via e-mail, may be displayed as option button 147. Option button 147 may display icon 149 and description 150. Consistent with embodiments of the invention, a user may select a different function from function menu 120, which may cause method 200 to return to stage 215.

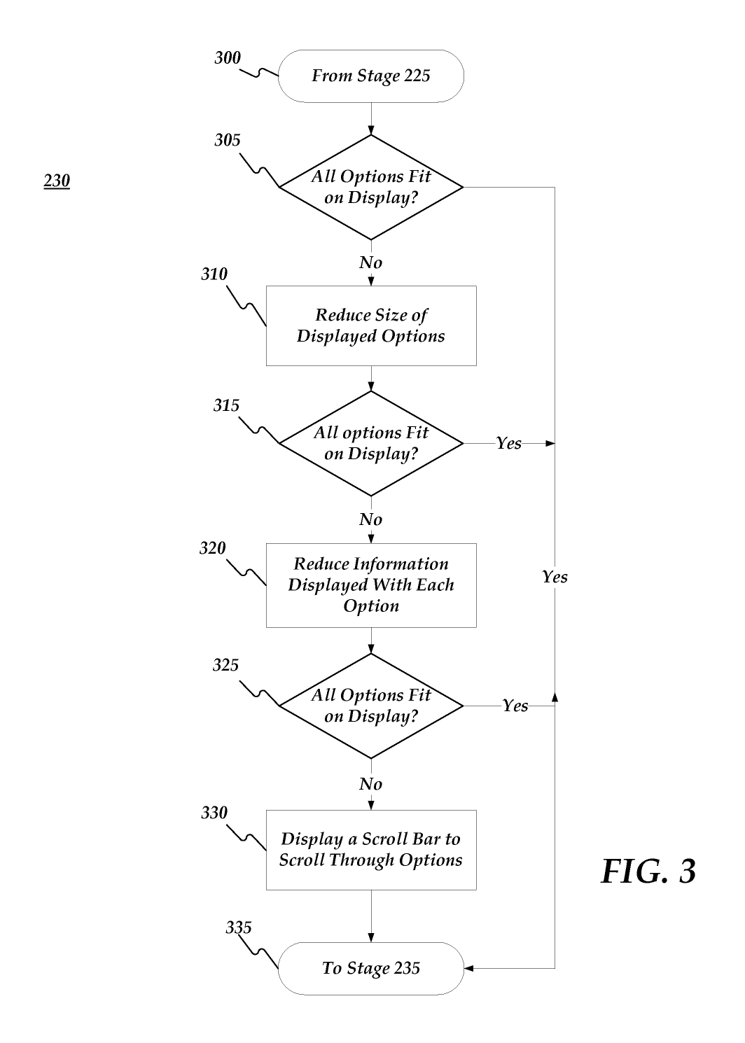

From stage 225, method 200 may advance to stage 230 where computing device 600 may adjust the display size of button slab 140 elements. Computing device 600 may display each category in at least one row and/or at least one column. Consistent with embodiments of the invention, options in a category may be laid out from right to left, left to right, top to bottom, and/or bottom to top order. Options and categories may be sorted according to at least one of alphabetical and most often used order. Further details regarding stage 230 will be described in more detail below with respect to FIG. 3.

From stage 230, method 200 may advance to stage 235 where computing device 600 may receive a selection of the at least one option. Consistent with embodiments of the invention, a user may use an input device 612 to select option button 147. For example, the selection may comprise at least one of a single click of a mouse, hovering over option button 147 with the mouse, and highlighting option button 147 using a keyboard.

From stage 235, method 200 may advance to stage 240, may display a description of the selected option. Consistent with embodiments of the invention, the description of the selected option may be displayed in button form slab 160 and provide additional information to the user to aid in selecting the option that best suits their needs. For example, the description may comprise an image, additional text information, a document formatting option, and a form to aid in implementing the selected option. The additional text information may comprise multiple paragraphs to provide greater details regarding the selected option. The image may also comprise a series of step-by-step instructional images. The description of the selected option may also be displayed in a tooltip adjacent to the selected option.

Consistent with embodiments of the invention, the form may comprise a series of labels and a form input area to aid the user in quickly implementing the selected option. For example, a send meeting request option may be associated with a form comprising a date selector and a time selector. The send meeting request option form may have access to the user's calendar and at least one recipient's calendar in order to help the user make a decision by suggesting a possible meeting time. Computing device 600 may then receive input to the form.

From stage 240, method 200 may advance to stage 245 where computing device 600 may determine whether any modifications may be made to a document based on the selected option. For example, a publish to web page option may comprise generating web links in the document.

From stage 245, method 200 may advance to stage 250 where computing device 600 may determine whether the selected option is associated with a preview display. Computing device 600 may then generate the preview display comprising at least one portion of the electronic document modified in accordance with the selected option. Generating the preview display may comprise modifying the electronic document according to input received by a form associated with the selected option and displayed in button form slab 160. The preview display may further comprise at least one user interface element associated with the selected option and at least one instructional description. After computing device 600 generates the preview, computing device 600 may display the associated preview in button form slab 160. Consistent with embodiments of the invention, option buttons 147,148 in button slab 140 may comprise the preview display.

From stage 250, method 200 may advance to stage 255 where computing device 600 may receive a decision from a user to use the selected option. In response to the user's decision, computing device 600 may implement the modifications to the electronic document associated with the operation associated with the selected option. Consistent with embodiments of the invention, receiving the decision to use the selected option may comprise receiving an input from input device 612. For example, the user may select a commit button displayed in button form slab, double click the selected option, or press a key on a keyboard associated with using the selected option.

Once computing device 600 implements the modifications associated with the selected option to the electronic document in stage 255, method 200 may then end at stage 260.

FIG. 3 is a flow chart of a subroutine 230 used in the method of FIG. 2 for adjusting the size of elements in the display. Subroutine 230 may begin at starting block 300 and proceed to decision block 305 where computing device 600 may determine whether all of the options associated with the selected functionality fit on a display of output device 614. For example, if a user selects menu item 122 associated with a save function of application 620 from function menu 120, output device 614 may not have a large enough screen to display all of the options and categories associated with the save function at the same time.

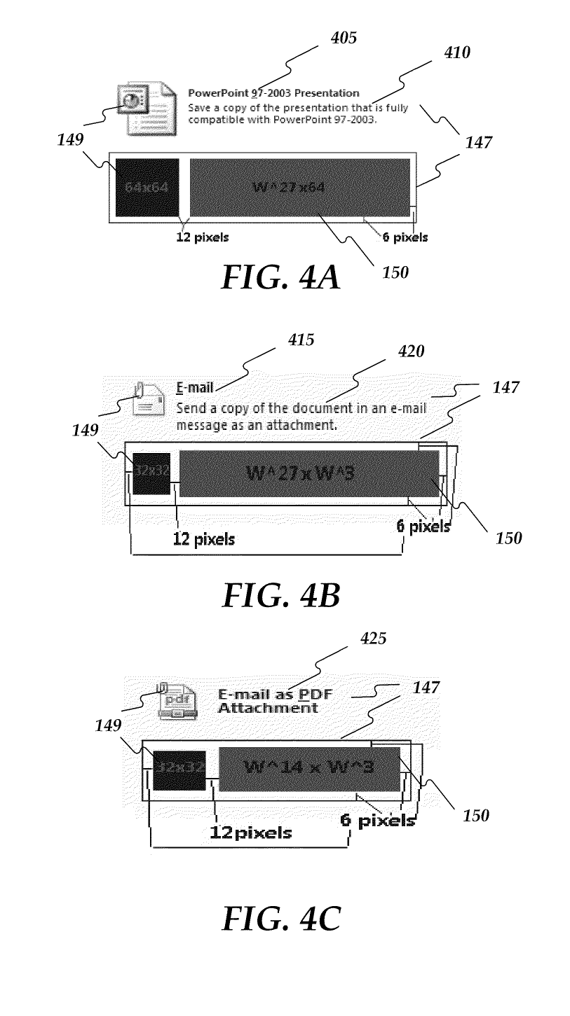

If not all option buttons may be displayed, subroutine 230 may advance from decision block 305 to stage 310, where computing device 600 may choose a smaller display size for each option button. For example, icon 149 associated with option button 147 may be reduced from 64×64 pixels to 32×32 pixels. Further details regarding the size reductions implemented by computing device 600 on option button 147 may be described in more detail below with respect to FIGS. 4A through 4C.

From stage 310, subroutine 230 may advance to decision block 315, where computing device 600 may determine whether the smaller size of each option button allows output device 614 to display all of the option buttons associated with the selected function. If all of the option buttons may be displayed, subroutine 230 may return to stage 235 of method 200.

From decision block 315, subroutine 320 may advance to stage 320, where computing device 600 may reduce the amount of information displayed in each option button. For example, button option description 150 may display a shortened label and/or description associated with the option, display only the label associated with the option, or be removed.

From stage 320, subroutine 230 may advance to decision block 325, where computing device 600 may determine whether the reduced amount of information allows output device 614 to display all of the option buttons associated with the selected function. If all of the option buttons may be displayed, subroutine 230 may return to stage 235 of method 200.

From decision block 325, subroutine 320 may advance to stage 330, where computing device 600 may display a scroll bar allowing a user to scroll through a list of each of the options associated with the selected functionality. Consistent with embodiments of the invention, stages 310, 320, and 325 may be used to adjust the display of button slab 140 at any time and in any order. Subroutine 230 may then return to method 200 at stage 335.

FIGS. 4A through 4C are screenshots illustrating different option button sizes. With respect to FIG. 4A, option button 147 may comprise icon 149 displayed at a 64 pixel×64 pixel resolution. Option button 147 may further comprise description 150. With respect to FIG. 4A, description 150 may comprise a label 405 and a text description 410. Consistent with embodiments of the invention, label 405 may comprise an area sized to fit a row of 27 ‘W’ characters as displayed in a system user interface font associated with operating system 605. Text description 410 may comprise an area sized to fit 2 rows of 27 ‘W’ characters as displayed in the system user interface font associated with operating system 605. Description 150 may then comprise an area sized to fit 3 rows of 27 ‘W’ characters as displayed in the system user interface font associated with operating system 605. The height of description 150's area may be equal to the height of icon 149. For example, in FIG. 4A, the height of description 150 and icon 149 are both 64 pixels. Option button 147 may comprise a width of 12 pixels between icon 149 and description 150, with a border width of 6 pixels comprising an edge of option button 147 measured from the taller of icon 149 and description 150.

With respect to FIG. 4B, option button 147 may comprise icon 149 displayed at a 32 pixel×32 pixel resolution. Option button 147 may further comprise description 150. Description 150 may comprise a label 415 and a text description 420. Consistent with embodiments of the invention, label 415 and text description 420 may comprise an area sized to fit three rows of 27 ‘W’ characters each as displayed in the system user interface font associated with operating system 605.

With respect to FIG. 4C, option button 147 may comprise icon 149 displayed at a 32 pixel×32 pixel resolution. Option button 147 may further comprise description 150. Description 150 may comprise a label 425. Consistent with embodiments of the invention, label 425 may comprise an area sized to fit three rows of 14 ‘W’ characters each as displayed in the system user interface font associated with operating system 605.

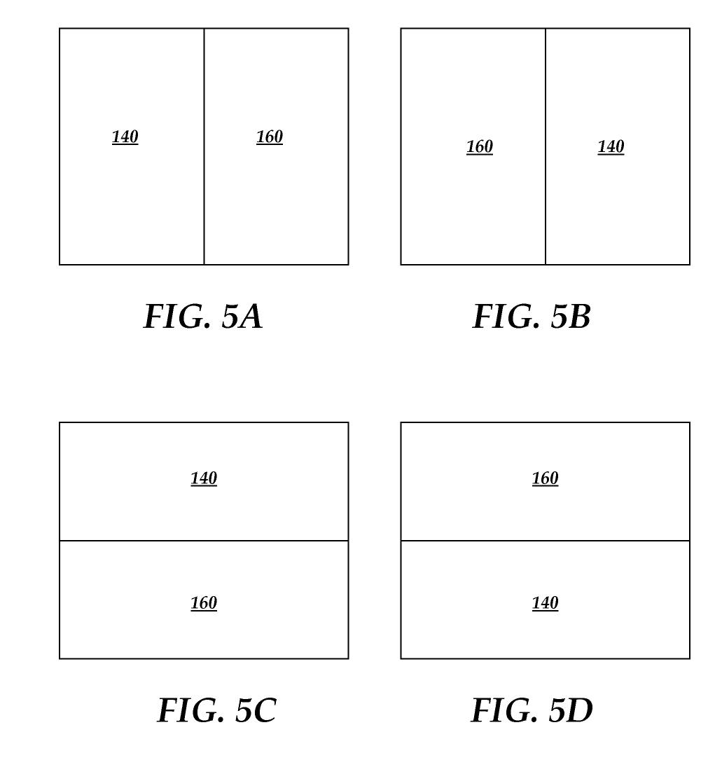

FIGS. 5A through 5D are block diagrams illustrating different layouts for button slab 140 and button form slab 160. Consistent with embodiments of the invention, button slab 140 and button form slab 160 may occupy different relative portions of an available display area of an output device 614. FIG. 5A illustrates a layout where button slab 140 is displayed to the left of button form slab 160. FIG. 5B illustrates a layout where button slab 140 is displayed to the right of button form slab 160. FIG. 5C illustrates a layout where button slab 140 is displayed above button form slab 160. FIG. 5D illustrates a layout where button slab 140 is displayed below button form slab 160. For example, the layout of button slab 140 and button form slab 160 may be changed based on a bidirectional setting in application 620 or an operating system 605.

Consistent with embodiments of the invention, computing device 600 may display button slab 140 separately from button form slab 160. For example, computing device 600 may replace the display of button slab 140 with a display of button form slab 160 in response to receiving a user's selection of option button 147.

An embodiment consistent with the invention may comprise a system for providing a method for comparing features in an application. The system may comprise a memory storage and a processing unit coupled to the memory storage. The processing unit may be operative to provide a display of various options for accomplishing a functionality associated with the application.

Another embodiment consistent with the invention may comprise a system for providing feature comparison in an application. The system may comprise a memory storage and a processing unit coupled to the memory storage. The processing unit may be operative to receive a selected functionality of the application, categorize the options for implementing the selected functionality, and display the options to a user in a layout designed to aid the user in choosing which option best suits their needs.

Yet another embodiment consistent with the invention may comprise a computer-readable medium for providing instructions for comparing and selecting functionality in an application. The computer-readable medium may comprise instructions for categorizing options for implementing the selected functionality. The computer-readable medium may further comprise instructions for adjusting the option display to simultaneously display as many options as possible.

FIG. 6 is a block diagram of a system including computing device 600. Consistent with an embodiment of the invention, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any of other computing devices 618, in combination with computing device 600. The aforementioned system, device, and processors are examples and other systems, devices, and processors may comprise the aforementioned memory storage and processing unit, consistent with embodiments of the invention. Furthermore, computing device 600 may comprise an operating environment for interface 100 as described above. Interface 100 may operate in other environments and is not limited to computing device 600.

With reference to FIG. 6, a system consistent with an embodiment of the invention may include a computing device, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, at least one programming module 606, and may include a program data 607. Operating system 605, for example, may be suitable for controlling computing device 600's operation. In one embodiment, programming module 606 may include an electronic document editing application, a spreadsheet application, an e-mail application, a presentation application, a web browser application, a calendar application, and a task list application. Furthermore, embodiments of the invention may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming module 606 (e.g. document editing application 620) may perform processes including, for example, at least one of method 200's stages as described above. The aforementioned process is an example, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for comparing features, the method comprising:
receiving a selection of a functionality of an application;
determining at least one option for implementing the selected functionality;
categorizing the at least one option for implementing the selected functionality;
displaying at least one category and the at least one option for implementing the selected functionality;
receiving a selection of the at least one option for implementing the selected functionality; and
displaying a description of the selected option for implementing the selected functionality.

2. The method of claim 1, wherein the application comprises functionality for editing an electronic document.

3. The method of claim 2, wherein the selected functionality of the application comprises saving the electronic document.

4. The method of claim 2, wherein the selected functionality of the application comprises sharing the electronic document.

5. The method of claim 2, wherein the selected functionality of the application comprises protecting the electronic document.

6. The method of claim 2, wherein determining the at least one option for implementing the selected functionality comprises at least one of selecting the at least one option from a statically defined list and dynamically determining the at least one option based on at least one property of the electronic document.

7. The method of claim 1, further comprising displaying a form associated with the selected option.

8. The method of claim 2, further comprising:
determining at least one modification to the electronic document associated with implementing the selected option; and
displaying a preview of at least a portion of the electronic document as it would be modified by the functionality of the selected option.

9. The method of claim 1, further comprising displaying at least one document formatting option associated with the selected option.

10. The method of claim 1, wherein displaying a description of the selected option for implementing the selected functionality comprises displaying at least one of a text description, an instruction, an image, and a form.

11. The method of claim 7, further comprising:
receiving input to the form associated with the selected option; and
displaying a preview of at least a portion of an electronic document as it would be modified by the received input prior to applying the modifications to the electronic document.

12. A system for comparing features in an application, the system comprising:
a display device;
a memory storage; and
a processing unit coupled to the memory storage, wherein the processing unit is operative to:
receive a selection of a functionality of the application;
determine a plurality of options for implementing the selected functionality;
categorize the plurality of options for implementing the selected functionality;
display a category header for each category associated with at least one of the plurality of options;
display, in proximity to the category header for each category associated with the at least one of the plurality of options, the at least one of the plurality of options associated with the category;
receive a selection of one of the plurality of options; and
display a description of the selected one of the plurality of options.

13. The system of claim 12 wherein the display of the plurality of options occupies an entirety of the display device.

14. The system of claim 12, wherein the display of the description of the selected one of the plurality of options for implementing the selected functionality comprises at least one of a text description, an instruction, an image, a form, and a preview of at least a portion of an electronic document.

15. The system of claim 12, wherein the processing unit is further operative to:
receive a selection of at least one other of the plurality of options; and
display a description of the selected at least one other of the plurality of options.

16. The system of claim 12, wherein if all of the plurality of options cannot be displayed on the display device, the processing unit is further operative to:
choose a subset of information associated with each of the plurality of options; and
display the subset of information associated with each of the plurality of options.

17. The system of claim 12, wherein each category associated with the plurality of options is displayed in at least one row and each of the plurality of options is displayed in at least one column.

18. The system of claim 12, wherein the display of the description of the selected one of the plurality of options replaces the display of the plurality of options.

19. A computer-readable medium which stores a set of instructions which when executed performs a method for comparing and selecting functionality in an application for editing an electronic document, the method comprising:
determining at least one function of the application, wherein the at least one function comprises at least one of sharing, saving, publishing, and protecting the electronic document;
determining at least one category of actions associated with the at least one function of the application;
determining at least one option associated with the at least one category of actions, wherein the at least one option comprises a title, a label, an icon, an operation, and a description;
determining whether the at least one category and at least one option may be displayed to a user;
in response to determining that the at least one category and at least one option may not be displayed to the user, choosing a smaller display size for the at least one option;
determining whether the smaller display size allows the at least one category and at least one option to be displayed to the user;
in response to determining that the smaller display size does not allow the at least one category and the at least one option to be displayed to the user, displaying a scroll bar;
displaying at least one category header associated with the at least one category of the at least one option;
displaying the at least one option associated with the at least one category header;
in response to the user selecting the at least one option, displaying the description of the at least one option;
determining whether the selected option is associated with a preview display;
in response to determining that the selected option is associated with the preview display, displaying the preview display wherein the preview display comprises at least one user interface element associated with the at least one option, at least one instructional description, and a modified portion of the electronic document displaying a result of applying the operation associated with the selected option;
receiving, from the user, a decision to use the at least one option; and
displaying a form comprising a plurality of user interface elements associated with implementing the operation associated with the selected option.

20. The computer-readable medium of claim 19, wherein displaying the at least one option associated with the at least one category header comprises displaying the modified portion of the electronic document.
